(19) United States
(12) Patent Application Publication
(10) Pub. No.: US 2007/0106531 A1
(43) Pub. Date: May 10, 2007

(54) Method and process that automatically finds patients for clinical drug or device trials

(76) Inventor: Daniel Deakter, Boca Raton, FL (US)

Correspondence Address: PILLSBURY WINTHROP SHAW PITTMAN LLP, P.O. BOX 10500, MCLEAN, VA, 22102, US

(21) Appl. No.: 10/567,534

(22) PCT Filed: Mar. 11, 2004
(86) PCT No.: PCT/US04/07409

§ 371 Date: Aug. 17, 2006

Related U.S. Application Data
(63) Continuation-in-part of application No. 10/618,418, filed on Jul. 11, 2003.
Application No. 10/618,418 is a continuation-in-part of application No. 10/290,725, filed on Nov. 8, 2002.
(60) Provisional application No. 60/453,680, filed on Mar. 11, 2003.

(51) Int. Cl. G06Q 10/00; G06F 17/00

(52) U.S. Cl. 705/2; 707/104.1

(57) ABSTRACT

A method and system to rapidly and precisely identify patient candidates for clinical trials comprises a database component operative to maintain a hospital patient database component and its plurality of hospital databases and their corresponding plurality of patient names and medical records, in communication with one or more medical practice database components and their corresponding plurality of specialties and their corresponding plurality of patient names and medical records. The method and system also include a clinical studies database component and its corresponding plurality of clinical studies, a communications component to receive changes to said database component, and a processor programmed to periodically match compatible patients and clinical studies, and to generate reports to medical practices in said medical practice database having matched patients. The processor may be programmed to search free text keywords and phrases last.

### CROSS REFERENCE TO RELATED APPLICATIONS

This application claims the benefit of U.S. Provisional Application No. 60/453,680 filed on Mar. 11, 2003 and is a continuation-in-part of U.S. patent application Ser. No. 10/618,418 filed on Jul. 11, 2003.

### BACKGROUND ART

This invention relates generally to the field of clinical research and more specifically to a method and system that automatically matches patients to clinical drug or device trials.

As the number of elderly people increase in the United States and their lifespans extend, there is an ever-increasing need for newer and safer pharmaceutical products. As such, there is a need for new drugs and medical devices to be approved more rapidly. With the mapping of the human genome it is estimated that drug targets and drugs will multiply tenfold, necessitating more clinical testing. In fact, The Pharmaceutical Research and Manufacturers of America (PhRMA) states that all drugs currently on the market are based on about 500 different targets. They expect this number to increase 600-2000%, to 3,000 to 10,000 drug targets in the coming years. However, such medical advances are outrageously expensive and have necessitated changes throughout the industry.

It is estimated to cost $880 million to bring one new drug to market, and it is estimated that the average pharmaceutical company has 70 new drugs in development. This has forced the pharmaceutical companies to consolidate for the purpose of underwriting the prohibitive expense of bringing a drug to market. The average drug takes 10 to 12 years to bring to market and must negotiate a series of 3 clinical trials before approval by the Food and Drug Administration (FDA) can even be granted, leaving 8 to 10 years on a drug patent to recoup costs and turn a profit. Factoring in the governmental and managed care cost containment pressures, the pharmaceutical companies must produce one blockbuster medicine every 18 months to survive.

In summary, the pharmaceutical companies are in a position where they are producing more new drug compounds than ever before; they are about to lose the patents on many of their highly profitable, blockbuster, drugs; and they are being squeezed by the managed care industry. It is therefore critical for the pharmaceutical companies to discover, test and market the maximum number of new drugs in the minimum amount of time.

In order to speed up this process, business efficiencies are being applied to the previously haphazard clinical trials process. According to a Tufts University study, each day a study is late a pharmaceutical company can lose $1.3 million in lost prescription drug sales and it can be as high as $10 million for a blockbuster drug. Clinical trials are for the most part paper-based; necessarily cumbersome; and slow to monitor, process and store. One of the key factors affecting the time it takes to complete a clinical trial or study is the time it takes to recruit, screen and refer patients to the study. Only when the study is completely populated with patients can testing begin. Currently, the haphazard methods to recruit patients can take up to a year and 25% of the duration of the clinical study and thus, it becomes no surprise that 75% of all clinical studies are completed late.

There are a number of web-based clinical trial management software programs which plan, administer, and process trials for pharmaceutical companies. Although less than 15% of drug trials are e-clinical trials, this number is expected to increase to 50% or more in the next few years. Such trials will allow realtime monitoring of trials for adverse drug reactions and quality control, as well as more efficiently, move and process the prodigious amount of data generated. However, one area which still has not been adequately addressed is patient recruitment.

Traditionally, patients for studies have been enrolled from an investigator's clinic or practice, via referrals or by advertising. One prior art publication that addresses this problem using the internet, is “Systems and Methods for Selecting and Recruiting Investigators and Subjects for Clinical Studies” U.S. patent application Pub. No. 2002/0002474 by Leslie Dennis Michelson and Leonard Rosenberg. Michelson and Rosenberg utilize an online web-based system to screen and enroll investigators and patients, and match patients to an appropriate investigator by zip code. Another prior art publication is entitled, “Recruiting A Patient Into A Clinical Trial”, U.S. patent application Pub. No. 2002/0099570 by Knight. Basically, Knight discloses how a patient with a particular disease may find a relevant study using a computer, a web browser and an Internet connection. Otherwise, the need for recruiting patients is served by databases of patients available for drug trials, or by programs that flag key words on dictated summaries using a search engine for evaluation for eligibility in studies, or by web-based patient enrollment programs. There are a number of websites where patients may do a preliminary application for eligibility and thereby enroll by this means.

These publications, however, do not utilize data as close to realtime as possible. They also do not systematically search all available places that patients may be found for drug trial enrollments. In particular, those websites that deal only with investigators comprise only 5% of all physicians, and a corresponding number of patients. Both Knight's and Michelson's methods do not systematically search for and find patients. It is believed that none of the known systems have a way to tap into the 95% of non-research preforming physicians to find and enroll their patients into studies.

A method that searches dictations and flags patients may be used in the offices of physicians with large practices who do research. These physicians are then paid for each patient found and for administering the study on that patient. However, these physicians are usually specialists who depend on referrals and it may take months for newly diagnosed patients to see the specialist and they comprise about 5% of the physician population.

Rao et al. describe methods for mining patient data in U.S. patent application Pub. Nos. 2003/0120458 and 2003/0130871. However, the methods of Rao et al. require the calculation of probability-based inferences of matching patients to clinical trials and not on direct matching of trial criteria with suitable patients. These methods also do not order search parameters to minimize the amount of text searching.

Therefore, based upon the foregoing, there is a need for a process that will tap a larger pool of patients more systematically, using data as close to realtime as possible with a level of precision not previously found and that will identify prospective patients at an earlier stage of their ailment before they see the appropriate specialist, to widen their treatment options.

### SUMMARY OF THE INVENTION

In light of the foregoing, it is a first object of the invention to provide a system to rapidly and precisely identify patient candidates for clinical trials comprising: a database component operative to maintain a hospital patient database component and its plurality of hospital databases and their corresponding plurality of patient names and medical records, and a medical practice database and their corresponding plurality of specialties and their corresponding plurality of patient names and medical records, and a clinical studies database component and its corresponding plurality of clinical studies; a communications component to receive changes to said database component; a communications component to receive changes to said database component; and a processor programmed to periodically match compatible patients and clinical studies, and to generate reports to matched medical practices in said medical practice database.

It is another object of the invention to provide a computerized method for matching patients to clinical medical studies, comprising: identifying a group of medical practices; identifying at least one clinical study; identifying a group of patients from a hospital database; maintaining a database identifying each said medical practice and each patient of said group of patients from said hospital database and each said clinical study; and comparing said medical practices and said clinical studies and matching one to the other.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed, a system for automatically matching patients to clinical trials comprising: a database component operative to maintain: one or more hospital patient database components and their one or more hospital databases and their corresponding plurality of patient names and their medical records, wherein the hospital patient database components are in communication with one or more medical practice database components and their corresponding plurality of specialties and their corresponding plurality of patient names and their medical records; a clinical studies database component and its corresponding plurality of clinical studies; a communications component to receive changes to said database component; and a processor programmed to periodically match compatible patients and clinical studies without reliance on calculation of probability-based inferences of matching, and generate reports to matched medical practices in said medical practice database component having one or more patients matched to at least one clinical study.

In accordance with a preferred embodiment of the invention, there is disclosed a computerized method for matching patients to clinical medical studies comprising: identifying a group of patients in a hospital database; identifying at least one clinical study; maintaining a database identifying each said patient in said hospital database and each said clinical study; and comparing said group of patients in said hospital database to said clinical studies and matching one or more patients in a hospital database to one or more clinical trials without reliance on calculation of probability-based inferences of matching.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic diagram of the system according to the present invention;

FIG. 2 is a schematic of the AI (Artificial Intelligence) Module;

FIG. 3 is a flow chart of the process according to the present invention;

FIG. 4A is a flowchart of the process used in classifying search parameters;

FIG. 4B is a flowchart of the process used in prioritizing search parameters and determination of search order;

FIGS. 5A, 5B, 5C, 5D, 5E, 5F are flowcharts of variations of the Search Process; and

FIG. 6 is a flowchart of the Text Recognition module.

### BEST MODE FOR CARRYING OUT THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

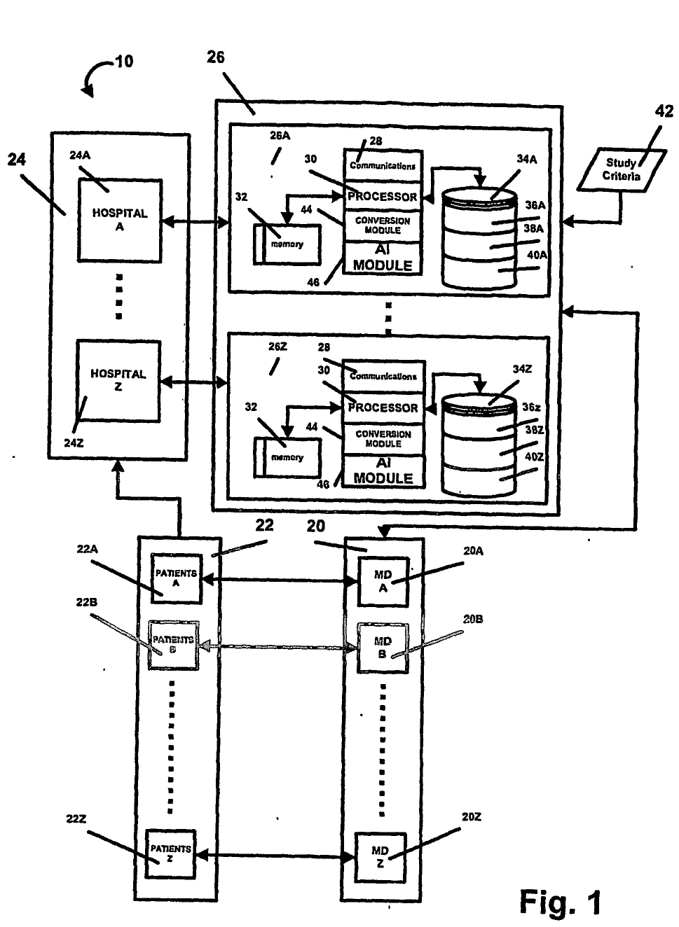

Referring now to FIG. 1 it can be seen that a system and related method for identifying patients for enrollment into a clinical trial is generally designated by the numeral 10. The system includes various organizations or entities that cooperate with one another for the purpose of identifying patients to be enrolled in medical studies. As discussed previously, sponsors of clinical trials, in order to eliminate bias from clinical testing, have to outsource their research to outside entities that actually do the research. One of the first steps to perform the trial is to find and enroll patients. One of the sources for finding patients are medical practices generally designated by the numeral 20 wherein any number of specific medical practices are provided with an alphabetic suffix. The patient population for each medical practice is generally designated by the numeral 22 and specifically each practice has a corresponding patient population each designated by a corresponding alphabetic suffix. These patient populations may be accessed through one or more hospitals to which the patients are referred. Optionally, patient populations may be accessed through the hospitals without reference to a referring medical practice. The hospitals are generally designated by the numeral 24 with each individual hospital represented by alphabetic suffixes. In the preferred embodiment of this invention, there is an identifier generally designated by the numeral 26 and specifically one associated with each hospital and designated by the same alphabetic suffix as its corresponding hospital. The identifier consists of a communications component 28 capable of receiving and sending communications in any number of forms, including but not limited to facsimile, page, email, voice text, website data entry and instant messaging. The identifier 26 includes a computer processor 30 which includes the necessary hardware, software and memory to implement the system and methodologies disclosed herein. The processor 30 is programmed, using a Conversion Module 44, to convert database information from incompatible operating systems to the operating system data types used by the processor. The processor 30 is programmed to load the eligibility criteria, implement a best search strategy based on prioritization of search criteria, utilizing the AI Module 46 also disclosed herein, and to output a report of matched patient clinical study and physicians. Moreover, each processor 30 is designed to access a database 34 each of which is designated by the same alphabetic suffixes as its corresponding hospital. The database comprises a studies database component 36, which contains the eligibility criteria for all the studies; a patient database component 38, also designated by the same alphabetic suffix as its corresponding hospital, containing clinical and demographic information that is a duplicate of the corresponding hospital database; and a physician database component 40, also designated by the same alphabetic suffix as its corresponding hospital, and comprising a plurality of medical practices. The processor 30 and communications component 28 are operative to maintain and update the database components. The selection process begins when clinical study criteria are transmitted to the communications component 28 of identifier 26.

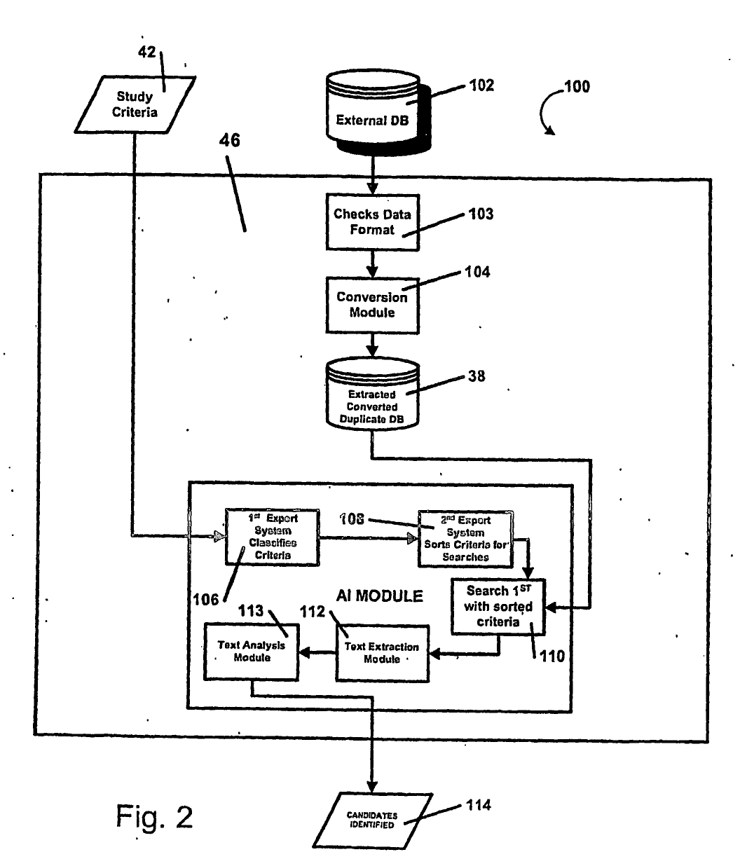

Referring now to FIGS. 1 and 2, the AI Module 46 and the process by which it is used in implementing system 10, is generally designated by the numeral 100. The external database information from hospitals 24 is input into the identifier 26 at step 102. At step 103, the processor 30 evaluates the data to determine if it is in a compatible format. If it is incompatible, the processor uses the conversion module 44 at step 104 to convert the data to a compatible format, such as conversion of 64 bit data from a VMS operating system to UNIX/LINUX 64. In either case, compatible data is then used to populate the various tables within the database 34. The conversion module employs a software emulator or other program which reads and converts files from one operating system to another to change the format of the data into a compatible format. The converted data files are then input into an extracted converted database at step 38, which is a duplicate of the information from each hospital 24. The study criteria 42 are input into the AI module 46 and in particular to a First Expert System at step 106, which classifies the criteria. The criteria is then input into a Second Expert System 108 which sorts the order of the criteria to search more efficiently. At step 110, the search begins utilizing the prioritized criteria list. The output of step 110 is a reduced subset of patients of the database 34 matching one or more of the criteria. This subset is then further searched at step 112 using a text extraction module which is detailed herein. The output of step 112 is then passed to the text analysis module 113, and the output of step 112 is further searched. This is the most compiler/CPU intensive part of the process and is, therefore, the last step before final matches are output, as the pool of candidates has, at this point, been maximally reduced. The text analysis increases the precision of the search process by extracting and processing data from text not revealed by the previous steps. The text analysis module may use semantic processing, contextual extraction, semantic networks, neural networks and the like. VisualText™ (Text Analysis International, Inc., Sunnyvale, Calif.) and similar natural language text analysis software is suitable for use as a text extraction module. This module 113 may be used to extract patient information from text such as histories and physicals, operative notes, pathology and radiology reports and the like. VisualText™ can scan a typical text document in about 0.25 seconds, and hence, should optimally be used as the last step in the search process for obtaining precise results as quickly as possible. For example, for a database having a size of 350 gigabytes, it is estimated that a text search of the entire database would take approximately 40 hours. However, if text searching is performed last in a series of inclusion and/or exclusion criteria, the text search is estimated to take approximately 90 minutes. The output at step 114 consists of the candidates identified for potential entry into clinical trials.

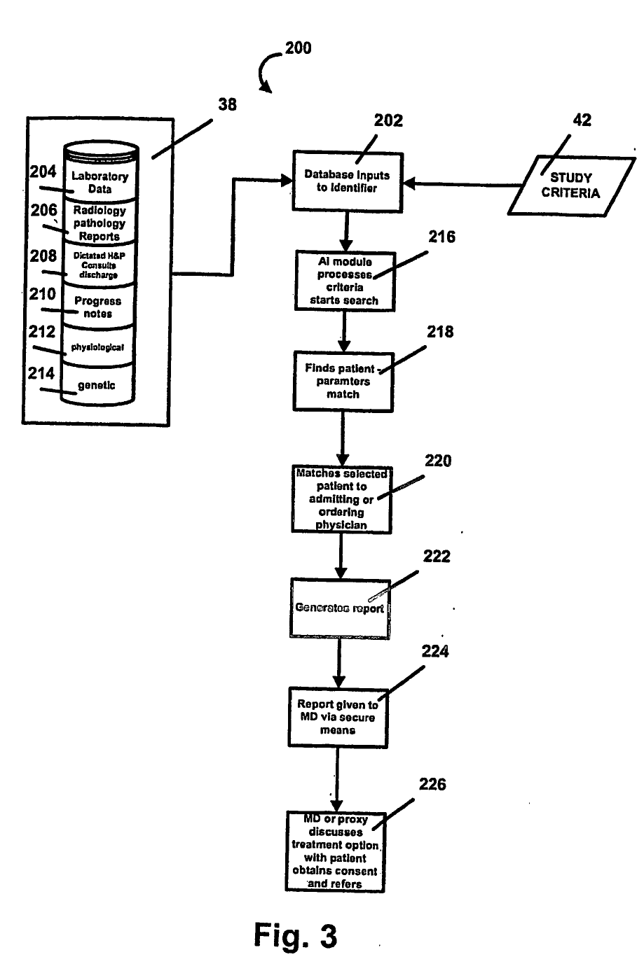

The process which is used in implementing system 10 may be further illustrated in FIG. 3, and generally designated by the numeral 200. The process utilizes the following steps to match patients to clinical studies. At step 202, the study criteria 42 are input into the database 38 of the identifier 26. The database typically includes such components as a laboratory result database component 204, a radiology and pathology report database component 206, dictated history and physical database component 208, dictated progress notes database component 210, physiological studies database component 212 which may include, but are not limited to, pulmonary function studies, cardiac catheterizations, electrocardiogram results, cardiac stress tests, esophageal manometry, hysterosalpingogram, bladder capacity test, nerve conduction tests and the like. The database may also include a genetic database component 214, which contains identified genes which are needed for studies that correct a disease caused by deficient gene. At step 216, the AI Module processes the criteria and searches the extracted database. At step 218, the processor 30 finds matches between the study criteria parameters and the patients. At step 220, selected patient study matches are paired with the admitting or ordering physician. The processor can be programmed to choose matches of 100% of criteria or another variable preset percentage. A report is generated at step 222 which may contain: patient name, title of the study that the patient quantifies for, a listing of the criteria that the patient has met and any criteria not met, if any, and the name of the admitting or ordering physician. Step 224 utilizes the communications component 28 and transmits a report to the physician via secure means, which includes but is not limited to encrypted email, sealed confidential envelopes handed to physician by a specially cleared person at the hospital similar to the current mechanism that confidential HIV results are transmitted to physicians in the hospital in accordance with the Privacy Rules of The Health Insurance Portability Act. Then, at step 226, the physician may verify the accuracy of the criteria, discuss treatment options with his or her patient, and obtain consent either to enroll the patient into a study or to refer the patient to a research site that does the study.

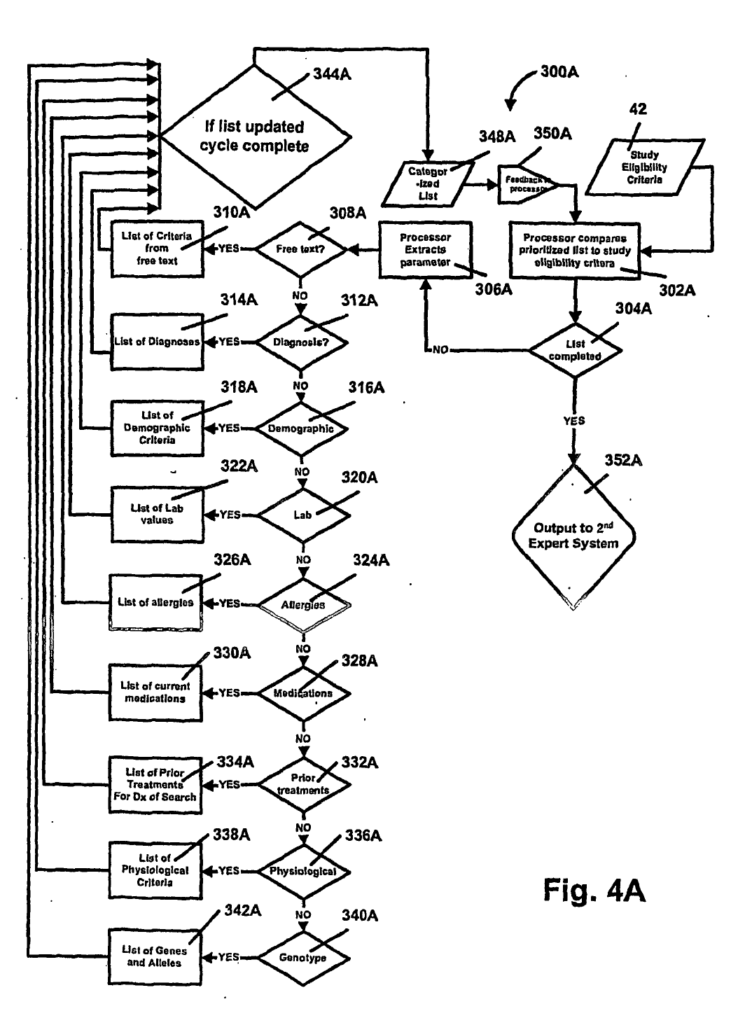

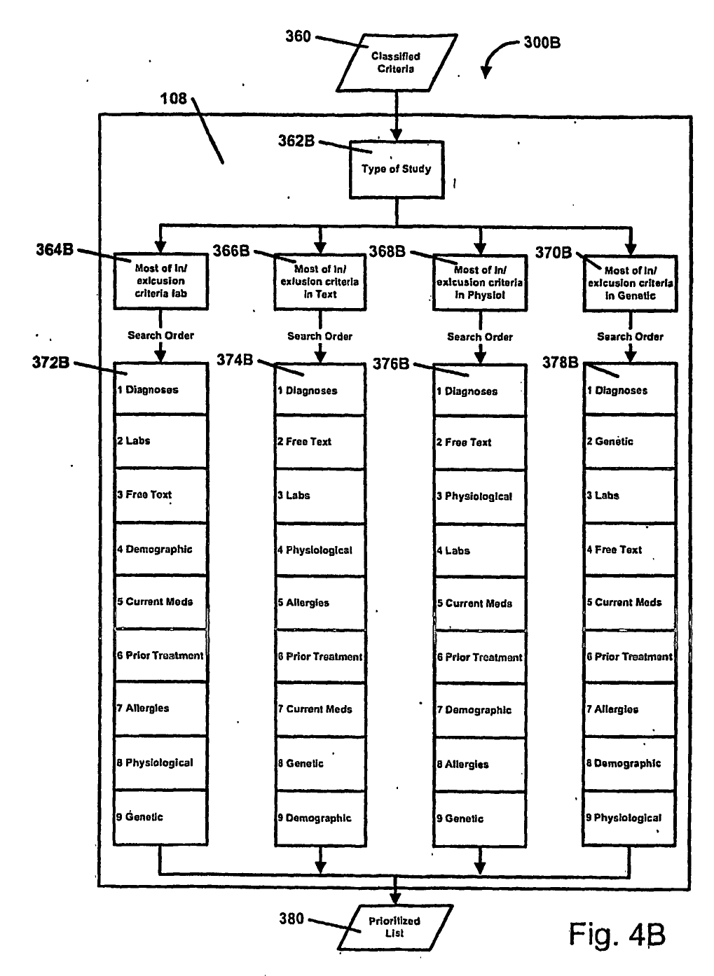

Referring now to FIG. 4A and to the Examples below, a detailed explanation of the generation of a prioritized list of search criteria will be discussed in detail. This part of the system and method is generally designated by the numeral 300A and describes the specific classifying processes of First Expert System 106. Efficient use of processor time and resources depend on minimizing the number of free text searches. Therefore it can be seen that by matching patients based on other criteria first and free text last, whenever possible, the pool of patients that will be searched for free text criteria will be greatly reduced.

This part of the process commences with the input of study eligibility criteria 42 to the processor 30. As the process is iterative, it is a necessary first step 302A to compare the eligibility criteria 42 to a predetermined categorized list of criteria. At the beginning, there will be no matches between the study criteria 42 and the categorized list of criteria. At all times where the prioritized list is incomplete, the match will not be complete and at the next step 306A the processor extracts the first or next criteria. At step 308A, the processor checks to see if the criteria is free text such as dictations of histories and physicals, discharge summaries and progress notes. If the criteria is free text, this information is stored on a separate list of free text criteria 310A, which is then input at step 344A to an updated list of criteria, and summed to create one list of categorized criteria at step 348A. The list of categorized criteria is then fed back to the processor 30 at step 305A to complete one iteration of the cycle. The cycle continues with a new comparison of the eligibility criteria to the list of criteria. If the criteria is not free text, other criteria categories are checked, such as diagnosis at step 312A, demographic data at step 316A, laboratory result at step 320A, allergy at step 324A, current medication patient is taking at step 328A, prior treatments at step 332A, physiological function test result at step 336A and lastly genotype test result at step 340A. Each of the foregoing steps 308A to 340A has a corresponding list 314A, 318A, 322A, 326A, 330A, 334A, 338A, and 342A that is updated depending on which criteria is matched. All the lists are fed into updated lists at step 344A and feedback to the processor at 350A. At step 302A, the processor again compares its master list to the study eligibility criteria 42. Each parameter is examined as described above until all parameters have been examined. When the categorized list matches the study eligibility list, the processor determines that the list is completed at step 304A and then the classified unprioritized list is output to a Second Expert System 108 at step 352A, to determine a sorting order such that free text searches are placed last on the list.

Referring now to FIG. 4B, the Second Expert System 108 is generally designated by the numeral 300B. The classified, unprioritized list 360 is determined at step 362B to be one of four types of studies. It can be a study where most of the inclusion/exclusion criteria are contained in the laboratory criteria such as that shown at step 364B, in which case its corresponding search order is enumerated by the list at 372B. Alternatively, it can have most of the inclusion/exclusion criteria in Free Text, as at step 366B, with its corresponding search order 374B. In another alternative, most of the criteria can be physiological, as in step 368B, with its corresponding search order 376B. Lastly, it may be that the predominant criteria are genetic, as in 370B, in which case the priority list at 378B reflects the importance of genetic and allelic data. In all cases a prioritized list is generated at 380 and searches can now commence.

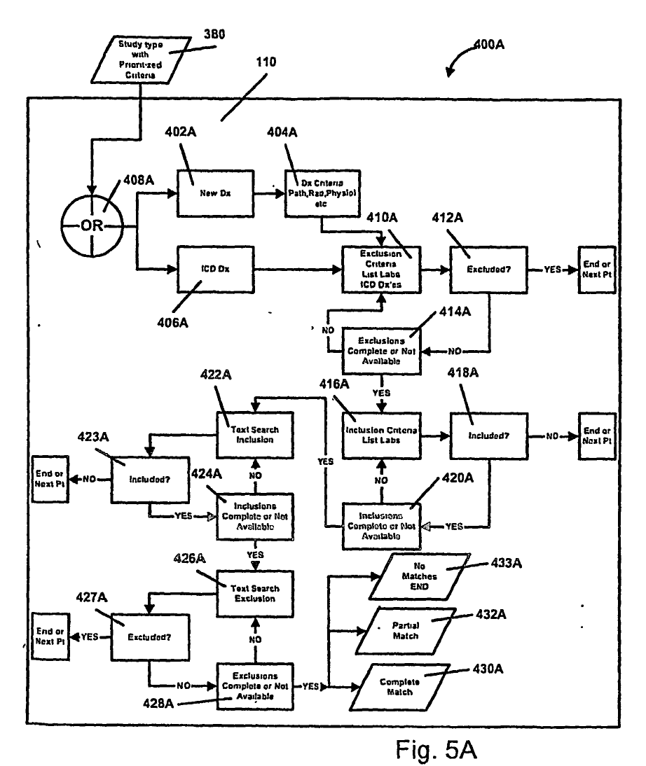

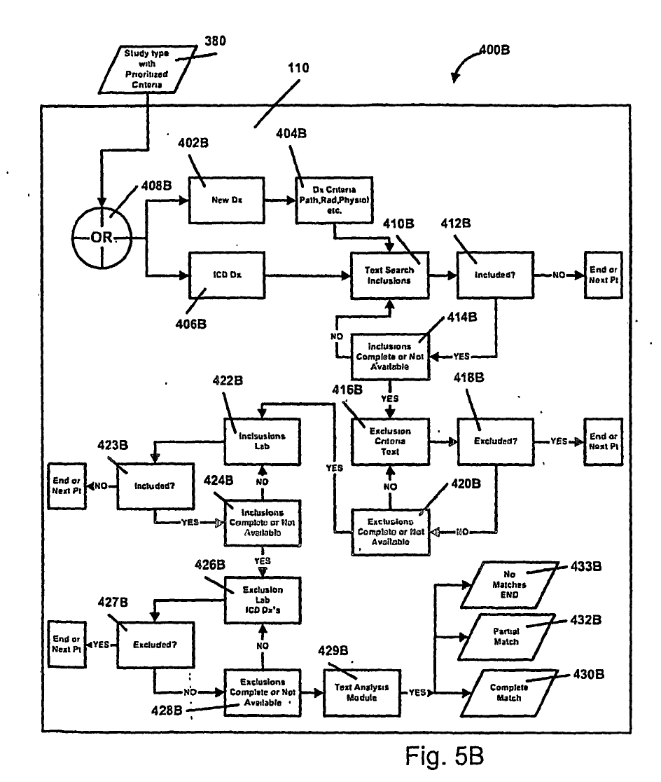

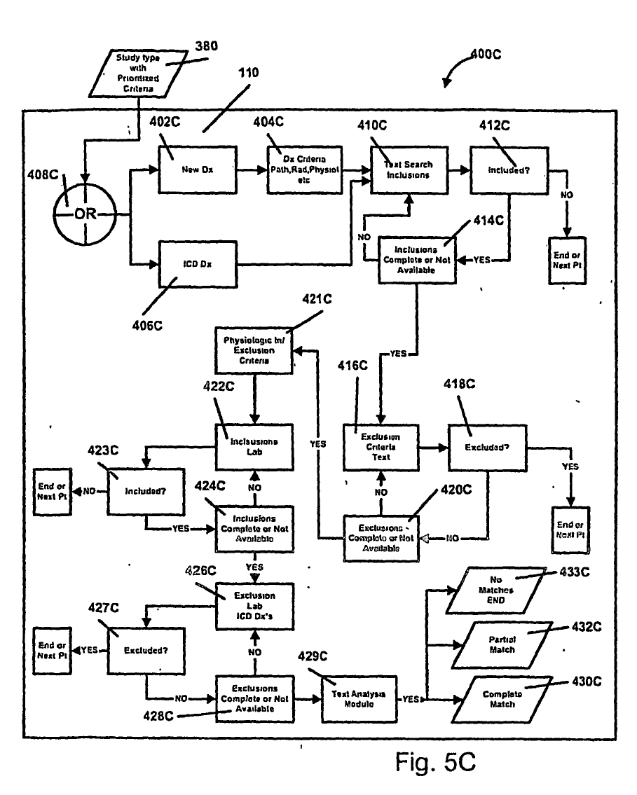

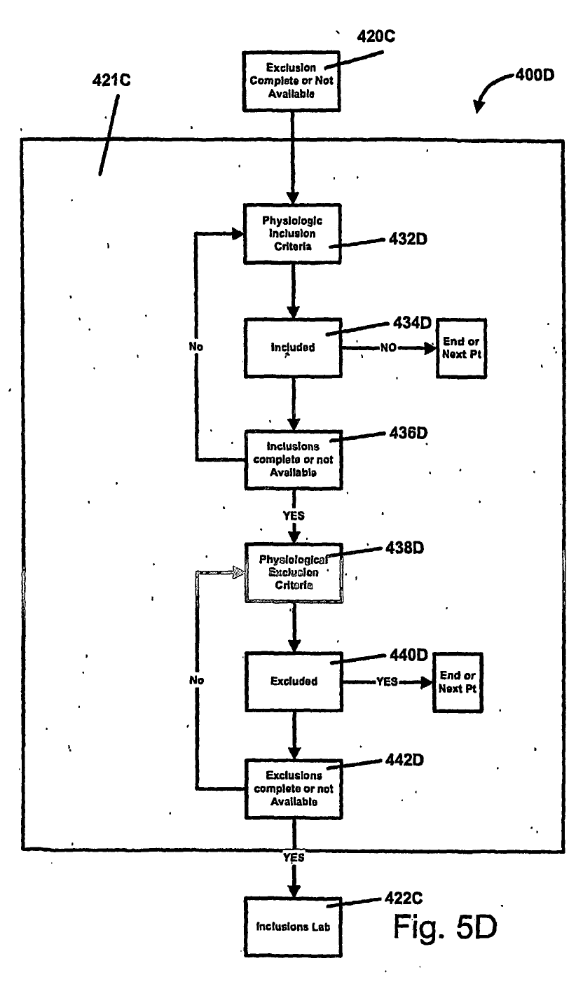

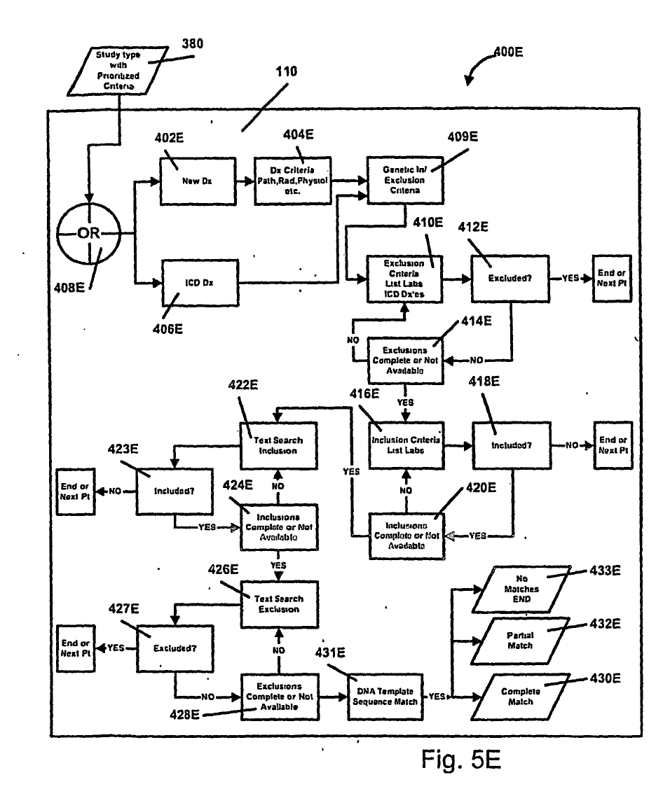

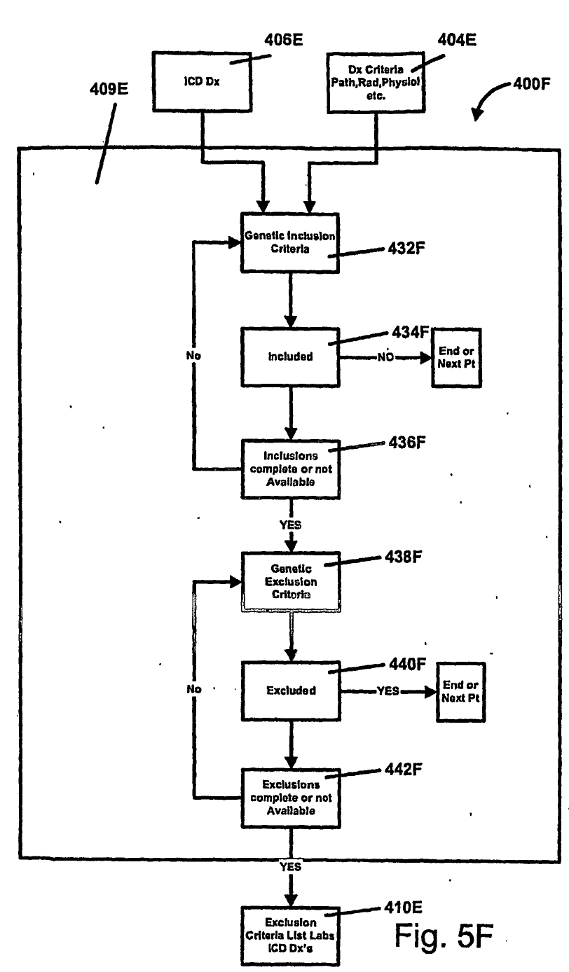

The search process is generally designated by the numeral 400A, 400B, 400C, or 400E, shown in FIGS. 5A, 5B, 5C and 5E, respectively, depending on the predominant search criteria type. If the sorted prioritized list 380 consists predominantly (60% or more) of laboratory test inclusion/exclusion criteria, the search follows the process of 400A. List 380 is input and examined at step 408A to determine if a new diagnosis is required (step 402A) or if an existing disease is required (step 406A). If a new diagnosis is required, the diagnostic criteria are examined and it is immediately searched for at step 404A. Only those patients whose records match this criteria are retained. Non-matching records are eliminated. If the diagnosis is known, then a search for an International Statistical Classification of Diseases and Related Health Problems (or ICD) code can be used to retain only those patients with the disease of interest. At step 410A, the list of exclusionary nontextual criteria is populated and then queried at step 412A. If the patient is not excluded, the processor checks to see if the criteria list has been exhausted at step 414A, and if not, it is iteratively utilized for matching. However, in this case, all matches are removed from the working subset of patients and are utilized in the next search step, leaving those who have not met any exclusions. When the list has been exhausted, inclusionary laboratory tests are listed at step 416A and checked against patient records at step 418A. The list is then checked at step 420A to see if it has been exhausted. If not, the remaining patient records are checked again at step 418A and those who remain when the list is exhausted, a still smaller subset of the original, are then sent to the text search inclusion module at step 422A utilizing the text extraction module 112 and later, the text analysis module 113. At step 423A, patients are determined to be included or excluded according to the text criteria. Of the subset that remains, the list of textual inclusion criteria is then checked for exhaustion at step 424A and if not exhausted, another text criteria is searched at steps 422A/423A and the patient is determined to be included or excluded. Again, only those patients who are included will be kept in the working subset. The list is then rechecked at step 424A and will recycle iteratively until the text inclusionary criteria list is exhausted. At step 426A, the text exclusionary criteria are searched, the patient is excluded or included at step 427A, and again, the remaining patients of that list are checked for exclusion and the search again iterates until the all of the criteria have been searched. The output of which is either a complete match at step 430A, a partial match at step 432A (because of missing data) or 433A where there are no matches, in which case, the search ends. The entire list of remaining patients is matched to their physicians of record and a report is generated and sent to their corresponding physicians.

If the list type is predominantly text inclusion/exclusion criteria, the search follows the process of 400B shown in FIG. 5B. List 380 is examined at step 408B to determine if a new diagnosis is required (step 402B) or if an existing disease is required (step 406B). If a new diagnosis is required, the diagnostic criteria are examined and it is immediately searched for at step 404B. Only those patients whose records match these criteria are retained. If the diagnosis is known, then a search for an ICD code can be used to retain only those patients with the disease of interest. At step 410B the list of inclusionary textual criteria is populated and then queried at step 412B. If the patient is not included, the processor checks to see if the list has been exhausted at step 414B, and if not, it is iteratively utilized for matching. However, in this case, all matches are removed from the working subset of patients, leaving those who have not met any inclusions. When the list has been exhausted, exclusionary text criteria are listed at step 416B and checked against patient records at step 418B. The list is checked at step 420B to see if it has been exhausted. If not, the remaining patient records are checked again at step 418B and those who remain when the list is exhausted, a still smaller subset of the original, are then sent to the LAB inclusion module at step 422B and checked for inclusion at step 423B. Of the subset that remains, patient records are checked against the list of laboratory test result inclusion criteria for exhaustion at step 424B and if not exhausted, another lab criteria is searched at steps 422B/423B and the list rechecked at step 424B. This will cycle until the laboratory test result inclusionary criteria list is exhausted. At step 426B the laboratory test result exclusionary criteria are searched, the patient list checked for exclusion at step 427B, and again of the remaining patients that list lab exclusions are checked for exhaustion and the search again iterates until the last criteria has been searched. After the exclusions list has been exhausted, the output of step 428B is passed to the text analysis module at step 429B. The text analysis step is the last step before final matches are output, again, to enhance precision and to analyze text for the smallest possible subset of patients. The output of step 429B is a complete match at step 430B, a partial match at step 432B (because of missing data) or no match at step 433B, in which case, the search ends. The entire list of remaining patients is matched to their physicians of record and a report is generated and sent to their corresponding physicians.

If the prioritized list type is predominantly physiologic inclusion/exclusion criteria, the search follows the process generally designated by the numeral 400C in FIG. 5C. The sorted prioritized list is examined at step 408C to determine if a new diagnosis is required (step 402C) or if an existing disease is required (step 406C). If a new diagnosis is required, the diagnostic criteria are immediately searched for at step 404C. Only those patients matching this criteria are retained. If the diagnosis is known, then an ICD code search can be used to retain only those patients with the disease of interest. At step 410C the list of inclusionary textual criteria is populated and then queried at step 412C utilizing the text extraction module 112. If the patient is not excluded, the processor checks to see if the list has been exhausted at step 414C and if not, it is iteratively utilized for matching. However, in this case, all matches are removed from the working subset of patients, leaving those who have not met any exclusions. When the list has been exhausted, exclusionary text criteria are listed at step 416C and checked against patient records at step 418C. The list is checked at step 420C to see if it has been exhausted. If not, the remaining patients are checked again at step 418C and those who remain when the list is exhausted, a still smaller subset of the original, are then sent to the physiologic inclusion/exclusion module shown in FIG. 5D. Then, at step 422C, a list of inclusionary laboratory tests are populated and the remaining patient records are examined at step 423C. The subset that remains, that is, those patient records that satisfy one or more of the inclusionary lab test criteria, is checked against the list of textual inclusion criteria for exhaustion at step 424C and if not exhausted, another text criteria is searched at steps 422C/423C and the list rechecked at step 424C. This will cycle until the text inclusionary criteria list is exhausted. At step 426C, the lab and ICD exclusionary criteria list is populated, searched at step 427C, and again the remaining patient records that list text exclusions are checked for exhaustion and the search again iterates until the last criteria has been searched. The output is a complete match at step 430C, a partial match at step 432C (because of missing data) or no match at step 433C, in which case, the search ends. The entire list of remaining patients is matched to their physicians of record and a report is generated and sent to their corresponding physicians.

Referring now to FIG. 5D, the physiologic inclusion/exclusion module is generally designated by the numeral 400D. Once the list of text exclusions have been exhausted at step 420C, as shown in FIG. 5C, the subset of patients remaining are examined. At step 432D, the physiologic inclusion criteria list is populated and patients are determined to be included or excluded at step 434D. At step 436D the list is check for exhaustion and if not exhausted, the remaining patients are checked for the next criteria on the list at 432D/434D. When the list is exhausted at step 436D the remaining patients are then checked for physiological exclusion criteria. The list of physiological exclusion criteria is populated at 438D and the remaining subset of patients are checked at step 440D for exclusions. At step 442D the list is checked for exhaustion. If there are remaining criteria to be checked the process iterates at steps 438D and 440D on the ever decreasing subset of patients. When the list of physiological exclusions is exhausted, inclusion labs criteria are checked at step 422C of FIG. 5C.

If the sorted prioritized list 380 is predominantly (60% or more) genetic inclusion/exclusion criteria, the search follows the process generally designated by numeral 400E as shown in FIG. 5E. The list 380 is examined at step 408E to determine if a new diagnosis is required (step 402E) or if an existing disease is required (step 406E). If a new diagnosis is required, the diagnostic criteria are immediately searched for at step 404E. Only those patients matching these criteria are retained. If the diagnosis is known, then an ICD code can be used to retain only those patients with the disease of interest. The genetic inclusion/exclusion criteria are checked by the genetic module at step 409E and further detailed in FIG. 5F. At step 410E, the list of exclusionary nontextual laboratory test results/ICD criteria is populated and queried at step 412E. If the patient is not excluded, the processor checks to see if the list has been exhausted at step 414E and if not, it is iteratively utilized for matching. However, in this case, all matches are removed from the working subset of patients leaving those who have not met any exclusions. When the list has been exhausted, inclusionary labs are listed at step 416E and checked at step 418E. The list is checked at step 420E to see if it has been exhausted. If not the remaining patients are checked again at step 418E and those who remain when the list is exhausted, a still smaller subset of the original, are then sent to the text search inclusion module at step 422E. At step 423E, patients are determined to be included or excluded. Of the subset that remains, the list of textual inclusion criteria is then checked for exhaustion at step 424E and if not exhausted, another text criteria is searched at step 422E/423E and the patients are determined to be included or excluded. Again only those patients who are included will be kept in the working subset. The list is then rechecked at step 424E and will recycle iteratively until the text inclusionary criteria list is exhausted. At step 426E, the text exclusionary criteria are searched, excluded or included at step 427E, and again of the remaining patients that list of text exclusions are checked for exhaustion and the search again iterates until the last criteria has been searched. The reduced set of patients are then searched at step 431E for a genetic data match, such as a DNA sequence match, PCR product match, or restriction fragment length polymorphism (RFLP), for example. The output is either a complete match at step 430E, a partial match at step 432E (because of missing data) or no match at step 433E, in which case, the search ends. The entire list of remaining patients is matched to their physicians of record and a report is generated and sent to their corresponding physicians.

Referring now to FIG. 5F, the genetic module is generally designated by the numeral 400F. Once the inclusionary diagnoses have been met at step 408E, shown in FIG. 5E, the subset of patients remaining are examined. At step 432F, the genetic inclusion criteria list is populated and patients are determined to be included or excluded at step 434F. At step 436F, the list is checked for exhaustion and if not exhausted, the remaining patients are checked for the next criteria on the list at steps 432F/434F. When the list is exhausted at step 436F, the remaining patients are then checked for genetic exclusion criteria. The list of genetic exclusion criteria is populated at 438F and the remaining subset of patients are checked at step 440F for exclusions. At step 442F, the list is checked for exhaustion. If there are remaining criteria to be checked the process iterates at steps 438F and 440F on the ever decreasing subset of patients. When the list of genetic exclusions is exhausted, inclusion labs criteria are checked at step 410E of FIG. 5E.

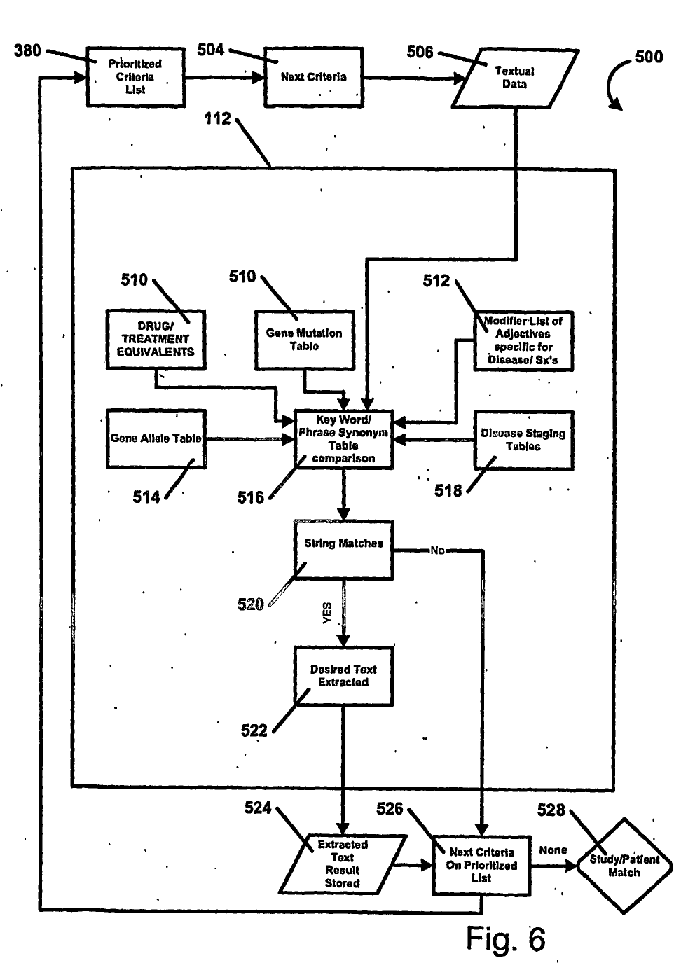

Referring now to FIG. 6, a textual search module is generally designated by the numeral 500. The prioritized list 380 is input and the first or next criteria is selected at step 504 and used to search the textual data at step 506. The textural data is checked against a table of similar diagnoses at step 512 or for similar phrases or against a table 518. The latter will take raw clinical information and classify it into standard disease conditions. Also, a gene allele table 514, which checks for membership in a gene family, may be checked. The relevant criteria together with its appropriate modifiers/staging/gene allele/mutation are compared to the parsed textual data. String matches are checked for at step 520 and if matches are not found, then the next criteria on the list is obtained at step 526 from the list 380 and the search iterates until all of the text criteria are exhausted. If there is a match at step 520, the desired text is extracted and the patient kept in the working subset of patients. When all textual criteria are exhausted, those records that matched the criteria are either output to be searched for other lab criteria or for further text analysis by any commercial text analysis software or output as a list of likely candidates for entry into a clinical trial, as in the latter case all other criteria have been exhausted.

### EXAMPLES

The examples below are lists of study eligibility and exclusion criteria for selected clinical drug trials. A study is listed by the title of the study in bold letters. The category of the criteria for the study is designated in bold brackets [category].

### Example 1

A Phase II Safety and Efficacy Study of Clarithromycin in the Treatment of Disseminated M. avium Complex (MAC) Infections in Patients With AIDS

Eligibility

Ages Eligible for Study: 13 Years and above, Genders Eligible for Study: Both Criteria

Inclusion Criteria

[CURRENT MEDICATION] Concurrent Medication: Allowed:

Didanosine (ddI).

Dideoxycytidine (ddC).

Zidovudine (AZT).

Acetaminophen.

Acyclovir.

Fluconazole.

Erythropoietin (EPO).

[DIAGNOSIS] Systemic Pneumocystis carinii pneumonia (PCP) prophylaxis (aerosolized or oral pentamidine, trimethoprim/sulfamethoxazole, or dapsone).

[CURRENT MEDICATION] Maintenance ganciclovir therapy (permitted only if dose and clinical and laboratory parameters have been stable for at least 4 weeks prior to study entry).

[CURRENT MEDICATION] Maintenance treatment for other opportunistic infections if the dose and clinical and laboratory parameters have been stable for 4 weeks prior to study entry. Patients must have:

[LABORATORY RESULT] Positive results for HIV by ELISA confirmed by another method.

[LABORATORY RESULT] Positive blood culture for Mycobacterium avium complex within 2 months of study entry and clinical symptoms of MAC infection.

[FROM FREE TEXT] Discontinued all mycobacterial drugs (approved and investigational) for at least 4 weeks prior to the start of drug therapy (with the exception of isoniazid prophylaxis which should be discontinued at Study Day minus 14 to Study Day minus 7)

[THIS WILL BE DONE AFTER THE PATIENT IS COUNSELED AND WILL NOT BE A SEARCH ENGINE CRITERION] Given written informed consent to participate in the trial.

Met the listed laboratory parameters in the pre-treatment visit.

[TREATMENT HISTORY] Prior Medication: Allowed:

Didanosine (ddI).

Dideoxycytidine (ddC).

Zidovudine (AZT).

Acetaminophen.

Acyclovir.

Fluconazole.

Erythropoietin (EPO).

[DIAGNOSIS] Systemic Pneumocystis carinii pneumonia (PCP) prophylaxis (aerosolized or oral pentamidine, dapsone, trimethoprim/sulfamethoxazole).

[CURRENT MEDICATION] Maintenance ganciclovir therapy (permitted only if dose and clinical and laboratory parameters have been stable for at least 4 weeks prior to study entry).

Exclusion Criteria

Co-existing Condition: Patients with the following conditions or symptoms are excluded:

[DIAGNOSIS] Active opportunistic infections. Maintenance treatment for other opportunistic infections will be permitted if the dose and clinical and laboratory parameters have been stable for 4 weeks prior to study entry.

[CURRENT MEDICATION] Concurrent Medication: Excluded:

Aminoglycosides.

Ansamycin (rifabutin).

Quinolones.

Other macrolides.

Clofazimine.

Cytotoxic chemotherapy.

Rifampin.

Ethambutol.

Immunomodulators (except alpha interferon).

Investigational drugs (except ddI, ddC, and erythropoietin).

Patients with the following are excluded:

[ALLERGY] History of allergy to macrolide antimicrobials.

[CURRENT MEDICATION] Currently on active therapy with any anti-mycobacterial drugs listed in Exclusion Prior Medications.

[CURRENT MEDICATION] Currently on active therapy with carbamazepine or theophylline, unless the investigator agrees to carefully monitor blood levels. Inability to comply with the protocol or judged to be near imminent death by the investigator.

[DIAGNOSIS] Active opportunistic infections.

[DIAGNOSIS] Requiring any of the excluded concomitant medications.

prior Medication: Excluded for at least 4 weeks prior to study entry:

[TREATMENT HISTORY] All anti-mycobacterial drugs (approved and investigational) with the exception of isoniazid

### Example 2

A phase II study of lopinavir/ritonavir in combination with saquinavir mesylate or lamivudine/zidovudine to explore metabolic toxicities in antiretroviral HIV-infected subjects Eligibility

[DEMOGRAPHIC] Ages Eligible for Study: 18 Years and above, Genders Eligible for Study: Both

Criteria

Inclusion Criteria:

[TREATMENT HISTORY] 1. Subject is naïve to antiretroviral treatment (subjects may not have more than 7 days of any antiretroviral treatment).

[DEMOGRAPHIC] 2. Subject is at least 18 years of age, inclusive.

[WILL BE CHECKED BY MD AND WILL NOT BE PART OF SEARCH CRITERIA] If female, subject is either not of childbearing potential, defined as postmenopausal for at least 1 year or surgically sterile (bilateral tubal ligation, bilateral oophorectomy or hysterectomy), or is of childbearing potential and practicing one of the following methods of birth control: condoms, sponge, foams, jellies, diaphragm or intrauterine device (IUD), a vasectomized partner, total abstinence from sexual intercourse

[LABORATORY RESULT] If female, the results of a urine pregnancy test performed at screening (urine specimen obtained no earlier than 28 days prior to study drug administration) is negative.

[WILL BE CHECKED BY MD AND WILL NOT BE PART OF SEARCH CRITERIA] Subject is not breast-feeding.

[FREE TEXT FROM PHYSICAL EXAMINATION] Vital signs, physical examination and laboratory results do not exhibit evidence of acute illness.

[DIAGNOSIS]. Subject has no significant history of cardiac, renal, neurologic, psychiatric, oncologic, endocrinologic, metabolic or hepatic disease that would in the opinion of the investigator adversely affect his/her participating in this study.

[CURRENT MEDICATION] Subject does not require and agrees not to take any of the following medications for the duration of the study: midazolam, triazolam, terfenadine, astemizole, cisapride, pimozide, propafenone, flecainide, certain ergot derivatives (ergotamine, dihydroergotamine, ergonovine, and metheylergonovine), rifampin, lovastatin, simvastatin, and St. John's wort.

[TO BE PART OF CONSENT AND WILL BE REMOVED FROM SELECTION CRITERIA] Subject agrees not to take any medication during the study, including over-the-counter medicine, alcohol or recreational drugs without the knowledge and permission of the principal investigator.

[DIAGNOSIS] Subject has not been treated for an active AIDS-defining opportunistic infection within 30 days of screening.

[LABORATORY RESULT] Subject has a plasma HIV RNA level of greater than 400 copies/mL at screening.

[TO BE PART OF CONSENT AND WILL BE REMOVED FROM SELECTION CRITERIA] Subject agrees to take all doses of the study drug from the bottles provided by the sponsor (rather than other containers, i.e., “pill box”).

[TO BE PART OF CONSENT AND WILL BE REMOVED FROM SELECTION CRITERIA] Subject has voluntarily signed and dated an informed consent form, approved by an Institutional Review Board (IRB)/Independent Ethics Committee (IEC), after the nature of the study has been explained and the subject has had the opportunity to ask questions. The informed consent must be signed before any study-specific procedures are performed.

Exclusion Criteria:

[ALLERGY] Subject has a history of an allergic reaction or significant sensitivity to LPV/r, INV or Combivir.

[DIAGNOSIS] Subject has a history of substance abuse or psychiatric illness that could preclude adherence with the protocol.

[LABORATORY RESULT] Screening laboratory analyses show any of the following abnormal laboratory results: •Hemoglobin >10.0 g/dL •Absolute neutrophil count >1000 cells/μL •Platelet count >50,000 per mL •ALT or AST<3.0×Upper Limit of Normal (ULN) •Creatinine<1.5×Upper Limit of Normal (ULN)

[TREATMENT HISTORY] Subject has received any investigational drug within 30 days prior to study drug administration.

[TO BE DETERMINED BY RESEARCH SITE] For any reason, subject is considered by the investigator to be an unsuitable candidate for the study

### Example 3

Iressa/Docetaxel in Non-Small-Cell Lung Cancer

Eligibility

[DEMOGRAPHIC] Genders Eligible for Study: Both

Criteria

Inclusion:

[DIAGNOSIS] Pathologically confirmed non-small cell lung cancer.

[DIAGNOSIS] Measurable, evaluable disease outside of a radiation port.

[PHYSIOLOGIC] ECOG performance status 0-2.

[LABORATORY RESULT] Adequate hematologic function as defined by an absolute neutrophil count >=1,500/mm3, a platelet count >=100,000/mm3, a WBC >=3,000/mm3, and a hemoglobin level of >=9 g/dl.

[TREATMENT HISTORY] One prior chemotherapy regimen. This may include chemoradiation treatment.

[FROM FREE TEXT] Disease progression or recurrence within 6 months of last dose of chemotherapy in first chemotherapy regimen.

[TREATMENT HISTORY] At least a 2-week recovery from prior therapy toxicity.

[TO BE DONE WILL BE REMOVED FROM SELECTION CRITERIA] Signed informed consent.

[FROM FREE TEXT] Prior CNS involvement by tumor are eligible if previously treated and clinically stable for two weeks after completion of treatment.

Exclusion:

[TREATMENT HISTORY] Prior Iressa or other EGFR inhibiting agents

[TREATMENT HISTORY] Prior docetaxel therapy

[DIAGNOSIS] Other co-existing malignancies or malignancies diagnosed within the last 5 years with the exception of basal cell carcinoma or cervical cancer in situ.

[TREATMENT HISTORY] Any unresolved chronic toxicity greater than CTC grade 2 from previous anti-cancer therapy.

[FREE TEXT FROM DICTATIONS] Incomplete healing from previous oncologic or other major surgery.

[CURRENT MEDICATIONS] Concomitant use of phenyloin, carbamazepine, barbiturates, rifampicin, St John's Wort, anticoagulants.

[LABORATORY VALUE] Absolute neutrophil counts less than 1500×109/liter (L) or platelets less than 100,000×10⁹/liter (L).

[LABORATORY VALUE] Serum bilirubin greater than 1.25 times the upper limit of reference range (ULRR).

[DIAGNOSIS] In the opinion of the investigator, any evidence of severe or uncontrolled systemic disease, (e.g., unstable or uncompensated respiratory, cardiac, hepatic, or renal disease).

[LABORATORY VALUE] A serum creatinine >=1.5 mg/dl and calculated creatinine clearance <=60 cc/minute.

[LABORATORY VALUE] Alanine amino transferase (ALT) or aspartate amino transferase (AST) greater than 2.5 times the ULRR if no demonstrable liver metastases or greater than 5 times the ULRR in the presence of liver metastasis.

[LABORATORY VALUE] Evidence of any other significant clinical disorder or laboratory finding that makes it undesirable for the patient to participate in the trial.

[TO BE DETERMINED BY CONSENTING MD] Pregnancy or breast feeding The patient has uncontrolled seizure disorder, active neurological disease, or Grade >=2

neuropathy

[TREATMENT HISTORY] The patient has received any investigational agent(s) within 30 days of study entry.

[DIAGNOSIS] The patient has signs and symptoms of keratoconjunctivitis sicca or incompletely treated eye infection.

Expected Total Enrollment: 50

As can be seen from the above examples criteria vary widely from one study to the next. Currently there are about 4,000+ studies that are being conducted. In addition, finding patients for these studies is like looking for a needle in a haystack.

Based upon the foregoing, the present system can find most if not all of the criteria from patient's hospital records. This can be done faster, accurately and with more up to date information, than by hand searching of charts, advertising, weekly or monthly updates of a centralized database searched via its own search engine. In addition the system will be able to draw upon the practices of vast number of physicians and hospitals and therefore make available to the general population treatments that might not have previously been available.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for automatically matching patients to clinical trials comprising:
a database component operative to maintain:
one or more hospital patient database components and their one or more hospital databases and their corresponding plurality of patient names and their medical records, wherein said hospital patient database components are in communication with one or more medical practice database components and their corresponding plurality of specialties and their corresponding plurality of patient names and their medical records,
a clinical studies database component and its corresponding plurality of clinical studies;
a communications component to receive changes to said database component; and
a processor programmed to:
periodically match compatible patients and clinical studies without reliance on calculation of probability based inferences of matching, and generate reports to matched medical practices in said medical practice database component having one or more patients matched to at least one clinical study.

2. The system according to claim 1, wherein:
said database component identifies patient names associated with each medical practice in said medical practice database component; and
said processor generates reports to medical practices having identified patients, said reports including a listing of prospective patients for at least one clinical trial.

3. The system according to claim 1, further comprising:
a searching component for searching said clinical studies database component, and said one or more hospital patient database components,
wherein said communications component is adaptable to receive searching order instructions.

4. The system according to claim 3, wherein:
said processor is programmed with a rule-based system to vary search parameter priority, wherein said search parameter priority is set to search free text keywords or a phrase in a specified order.

5. The system according to claim 4, wherein:
said search parameter priority is set to search free text keywords or a phrase last.

6. The system according to claim 1 wherein said processor is further programmed to convert database information from incompatible operating systems to the operating system of the processor.

7. The system according to claim 1, wherein said clinical studies database contains clinical trials selected from the group consisting of clinical drug trials and clinical device trials.

8. A computerized method for matching patients to clinical medical studies comprising:
identifying a group of patients in a hospital database;
identifying at least one clinical study;
maintaining a database identifying each said patient in said hospital database and each said clinical study; and
comparing said group of patients in said hospital database to said clinical studies and matching one or more patients in a hospital database to one or more clinical trials without reliance on calculation of probability-based inferences of matching.

9. The method according to claim 8, further comprising:
maintaining said database to include a plurality of patient profiles associated with a corresponding medical practice; and
notifying a medical practice when at least one of said patient profiles matches the requirements of said clinical studies.

10. The method according to claim 8, wherein said step of maintaining a database further comprises converting data from an incompatible operating system to the operating system of the processor.
